(19) United States
(12) Patent Application Publication
(10) Pub. No.: US 2026/0267666 A1
(43) Pub. Date: Sep. 10, 2026

(54) Environmental Conditioning Device Configuration Manager

(71) Applicant: Budderfly, Inc., Shelton, CT (US)

(72) Inventors: Christopher John Read, Ridge, NY (US); Lee Tony Kaufman, Grafton, MA (US); Gerald Aaron Kaufman, Grafton, MA (US)

(21) Appl. No.: 19/553,202

(22) Filed: Feb. 27, 2026

Related U.S. Application Data
(60) Provisional application No. 63/766,411, filed on Mar. 4, 2025.

(51) Int. Cl. G06F 9/445

(52) U.S. Cl. CPC G06F 9/44505

(57) ABSTRACT

A system, device and method is provided for managing configurations of environmental conditioning units and for ensuring the environmental conditioning unit is configured in a manner appropriate for the particular installation. The disclosed features involve generating a configuration file which can be provided to a controller of an environmental conditioning unit to configure multiple settings for the environmental conditioning unit without the need to selectively choose each setting by going through an interface menu on the controller. The configuration file is stored in a format acceptable to and recognizable by the controller, usually as a backup or reboot file and includes unique identifiers and time stamps to allow for the configuration file to be utilized by the controller.

### FIELD OF THE INVENTION

The present disclosure relates to systems and methods of managing the configuration of environmental control units including, for example, HVAC (Heating, Ventilation, and Air Conditioning) units including RTUs (Roof Top Units) in facilities in such a way as to optimize energy savings and system efficiency.

### BACKGROUND OF THE INVENTION

Traditional HVAC units operate in what may be referred to as “dumb” mode in that an energy source (gas/oil/electric) is connected to the system as is a thermostat and when the thermostat calls for heat or cooling, the unit turns on, uses energy and delivers heating or cooling. When the thermostat no longer calls for heat/cooling, the unit shuts off. With an increased emphasis on efficiency and energy savings today's HVAC systems are provided with many configuration options which may be set differently for each specific location or installation. The HVAC unit may have multiple compressors, fans and may have a number of internal sensors and further have a computer able to run the unit to optimize efficiency in different ways, depending on various conditions/factors of the location. Thus, when the thermostat calls for heating or cooling, the HVAC unit will still turn on and deliver that heating or cooling, but the way in which the unit operates and how it turns on and to what extent it turns on may differ widely depending on what else is happening at the given time.

However, despite these newer HVAC units being provided with a myriad of settings and configuration options, the factory still will ship those units in “dumb” mode such that regular operation relies simply on a thermostat turning the units on or off and the unit turns on and off the same way regardless of what other conditions are occurring. The ability to operate the unit differently, for example turning on one of the two compressors, or cycling the unit in a different way or otherwise operating the unit differently when heat/cooling is called for, depending on the circumstances in question requires sophisticated understanding of the unit and its functions along with the ability and patience to program the unit correctly and the ability to fine tune that configuration.

In practice, these units are installed by technicians who do not have training sufficient to program the units effectively, especially because the different parameters/settings should be set differently depending on the installation and that different models/manufacturers may require different programming for better efficiency. The technician further does not usually have time required to spend programing the unit as the interface for programming is not particularly user friendly.

To achieve full efficiency of a given unit at a given site, the parameters and configuration must be set correctly, and the connection of the appropriate sensors must be made. In order to implement these settings, knowledge of the equipment is necessary. In many cases, the installer must be able to work with multiple sets of equipment which are also changing with updates and upgrades. Proper installation also varies depending on the facility and what sensors may be required to be installed and connected.

An entity tasked with installing and managing a large number of such facilities often runs into problems getting experienced installers that are knowledgeable with the complex equipment and its proper installation and configuration. Even with the best of training and documentation inconsistencies and errors are commonplace. As a result of the foregoing, these new and ultra efficient units are often installed in “dumb” mode whereby all gains in efficiency are not realized due to less than optimal programming and configuration.

What is more problematic, is that even when improperly configured and installed, one can easily walk away from a facility with the impression that all is working well. An installer may put their hand in front of the vent and feel cold air blowing and get the impression that the system is working great. Furthermore, given that the unit is often replacing an older one, simply choosing a new unit almost automatically results in efficiency increases even if not optimally programmed, thus it may be difficult to understand or even know that the unit is improperly installed as energy usage may go down compared to the replaced unit and the new unit is functioning correctly. Thus, the end user sees better efficiency compared to the former unit, but, it is just not as high of an efficiency result as is possible. Thus, when it comes to energy efficiency and energy savings, the system may be far from optimal in terms of settings and configuration.

Installers are also often paid by the installation and are not incentivized to run detailed diagnostics to research and fine tune the configuration. They are often quick to dismiss anything amiss to check off the installation and proceed to the next paying install. Even those conciencious enough to run more tests to ensure the configuration is well done, some settings may be ideal for the moment, but programming for longer term is difficult to determine in the short installation window.

U.S. Pat. No. 7,590,469 to Grohman describes a method for configuring a communicating environmental conditioning network having a plurality of environmental interactive units communicating coupled with a plurality of space interactive units, each respective space interactive unit presenting a conditioned output when engaged with a particular environmental interactive unit. Grohman however fails to provide a user friendly solution to enforce correct configuration and does not solve the problem of technicians failing to be trained to handle the configuration or failing to understand how to correctly configure the unit in different situations. Grohman fails to provide pre-configured settings based on known installations and sensors for units that avoids the need for on site step by step configuration implementation.

Australian patent AU 2019221098B2 to Venne, titled Systems and methods of optimizing HVAC control in a building or network of buildings describes A system and method for managing all of the HVAC components of a building so they operate like one optimized ecosystem. Venne focuses on optimizing control of HVAC systems for delivery of heating/cooling based on managing zones, temperature settings and the like. However, Venne does not focus on the actual configuration of the HVAC unit and how it converts the energy source into heating/cooling that is actually delivered to the building and like Grohman fails to provide a user friendly solution to enforce correct configuration and does not solve the problem of technicians failing to be trained to handle the configuration or failing to understand how to correctly configure the unit in different situations. Grohman fails to provide pre-configured settings based on known installations and sensors for units that avoids the need for on site step by step configuration implementation.

### SUMMARY OF THE INVENTION

The following presents a simplified summary of the claimed subject matter in order to provide a basic understanding of some aspects of the claimed subject matter. This summary is not an extensive overview and is intended to neither identify key or critical elements nor delineate the scope of the disclosure.

It is an object of the present invention to manage and deploy configuration files to locations based on the particular equipment at that site in a manner that allows an installer to easily configure a unit with multiple configuration settings at once.

It is an object of the present invention to avoid or reduce the need to utilize step by step on site configuration processes.

It is an object of the present invention to provide a central repository of pre-set configurations that can easily be used by any installer while allowing for continued enhancements to improve efficiency.

It is a further object of the present invention to provide a system for managing optimized configuration files for the correct combination of site type and installed equipment type such that these configuration files could be installed on the equipment at a given site to obtain maximum energy efficiency in a manner

It is a further object to provide a system which can manage and update configurations and ensure that the correct configuration is used at all facilities as the configurations are optimized over time. The system would classify new sites into known categories based on similar sites in the installed base of the entity managing such sites. When configuration are updated, the system would, depending on the urgency, schedule and plan upgrades to be done immediately or scheduled for the next service call.

It is a further object of the invention to provide a system of managing configuration files based on known parameters about the site including geographical zone, equipment type, installation type, and building type. Further, parameters about the operation which can include business volume, menu type or food types, indoor dining or take out, drive through or pickup capability, among other things. These may all affect the amount of cooling required, when it is required and thus the programming of the RTU and which sensors may be needed to gather the appropriate inputs.

It is a further object of the invention to provide a mechanism to validate the configuration of a given site to ensure that the proper configuration is entered including: (a) sampling one or more key parameters; (b) providing a checksum for the configuration file; (c) providing detailed version information included with the configuration file; (d) date and time stamping the configuration file; and/or (e) serializing the configuration file to be unit specific.

It is a further object of the invention to provide a mechanism for notifying or scheduling upgrades to existing configurations based on urgency through integration with a work force management system or creating alerts and notifications that can enable the above.

It is a further object of the invention to provide a mechanism for notifying or scheduling upgrades to existing configurations based on monitored performance and adjusting configuration parameters as a result of measured performance where these are likely to provide greater efficiency.

In some aspects a method is provided for configuring environmental conditioning units and includes providing a selection indicative of one or more environmental conditioning units having one or more sensors, at least one of the environmental conditioning unit having a controller providing an interface for selection of a plurality of configuration options at least some of which relate to the one or more sensors; generating, with a software executing on a computer, a configuration file based on said selection, said configuration file having two or more of said plurality of configuration options included therein as chosen configuration settings; and providing said configuration file via the storage to the controller to implement the configuration file within the controller such that the at least one of the one or more environmental conditioning units operates with the one or more sensors based on the configuration file and the configuration file includes a plurality of configuration settings which would otherwise be selectively chosen via the interface but which configuration options, by implementation of the configuration file are configured in the controller without navigation through the interface for each of the plurality of configuration settings.

In certain aspects prior to providing said configuration file to the controller, said configuration file is saved to a storage which is removable from communication with said computer and providing said configuration file includes connecting said storage to the controller. In other aspects said configuration file is provided to the controller wirelessly from said computer. In still other aspects said computer is a mobile device. In yet other aspects the configuration file on said storage is stored with a file structure and a format which is acceptable by said controller. In yet further aspects, said structure and format is recognizable by said controller as a backup or reboot file such that the controller accepts the configuration file as if the controller were restoring or rebooting from said configuration file. In still other aspects, the configuration file includes a plurality of files.

In yet other aspects a device is provided for configuring environmental conditioning units. Software is provided which executes on a computer. The software is configured to receive installation details comprising: information indicative of an environmental conditioning unit type and unique identifier and at least one installation information associated with installation of the environmental conditioning unit at a site. The software is configured to identify a removable storage and to format said removable storage based on the installation details and said software further configured to generate a configuration file for the environmental conditioning unit and store said configuration file on the storage. The configuration file is configured such that the at least one of the one or more environmental conditioning units operates based on the configuration file and the configuration file includes a plurality of configuration settings which would otherwise be selectively chosen via an interface of a controller of the environmental conditioning unit but which configuration options, by implementation of the configuration file are configured in the controller without navigation through the interface for each of the plurality of configuration settings.

In certain aspects the configuration file on said removable storage is stored with a file structure and a format which is acceptable by said controller. In other aspects said structure and format is recognizable by said controller as a backup or reboot file such that the controller accepts the configuration file as if the controller were restoring or rebooting from said configuration file. In still other aspects said format is matched to a format acceptable to the controller based on the environmental conditioning unit type. In still other aspects said configuration file includes the unique identifier. In other aspects the unique identifier is contained in a file name of the configuration file. In yet other aspects a storage accessible to said software and containing data indicative of configuration settings to be used based on which installation details are selected at the software such that the configuration file is generated by said software based on the data.

In yet other aspects a method is provided for configuring an environmental conditioning device and includes providing a storage containing a configuration file particular to an environmental conditioning unit type and unique identifier and at least one installation information associated with installation of an environmental conditioning unit at a site; and connecting said storage to a controller of the environmental conditioning unit at the site to configure a plurality of settings of the environmental conditioning unit based on the configuration file such that the controller obtains the plurality of settings from the configuration file which settings would otherwise be selectably chosen via an interface of a controller of the environmental conditioning unit but which configuration options, by implementation of the configuration file are configured in the controller without navigation through the interface for each of the plurality of configuration settings.

In certain aspects the controller includes a controller storage, and the configuration file is transferred from the storage to the controller storage and stored on the controller storage. In other aspects, the configuration file on said storage is stored with a file structure and a format which is acceptable by said controller. In other aspects said structure and format is recognizable by said controller as a backup or reboot file such that the controller accepts the configuration file as if the controller were restoring or rebooting from said configuration file. In other aspects, the configuration file includes a plurality of files. In still other aspects the configuration file includes the unique identifier in the file name and the controller recognizes the configuration file based on the file name.

Other objects of the invention and its particular features and advantages will become more apparent from consideration of the following drawings and accompanying detailed description.

### DRAWINGS

FIG. 1A is a functional flow diagram of the software for generating a configuration file.

FIG. 1B is a functional flow diagram showing additional details of FIG. 1A.

FIG. 1C shows an overview of the configuration file creation according to aspects of FIGS. 1A-C.

FIG. 2 shows the update mechanism for the configuration manager of FIGS. 1A-1C.

FIG. 3 shows a sample controller with interface for an environmental conditioning unit.

FIG. 4 shows a sample display menu for the interface of FIG. 3.

FIG. 5 shows part of an example configuration file for an environmental conditioning unit according to FIGS. 1A-C and 2.

FIG. 6 shows the arrangement of several facilities within the system provided herein.

### DETAILED DESCRIPTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

Some specific examples follow of configuration parameters on HVAC units such as RTU units that are often overlooked or mistakenly set to the wrong settings resulting in lower efficiency or potentially problematic operation by a unit in a given installation, but it is understood that this disclosure applies generally to environmental control/conditioning devices of all types, such as but not limited to Make-up Air Units (MAU), Roof Top Units (RTU), Ground Units (GU), Air Handler Units (AHU).

In one configuration, a system and method is provided that allows for a configuration filed to be loaded onto a USB stick, thumb drive, or a form of portable media that can be brought by the installer on site. The portable media contents can be preloaded or provided electronically for the installer or an intermediary to upload (optionally). The configuration file will be tailored to the equipment on site including the particular unit (e.g. HVAC, heater, air conditioner, heat pump etc.) and any associated peripherals (e.g. indoor sensors, outdoor sensors, thermostats, data connections/feeds etc.). The file structure on the USB device is one that the controller/unit being configured is compatible with. For example, the incorrect format or file structure may cause permanent damage to the controller in some cases to render the controller inoperative and not fixable. Thus, the format, file structure and contents of the USB drive are important not only to configuring the unit properly, but also not damaging the unit.

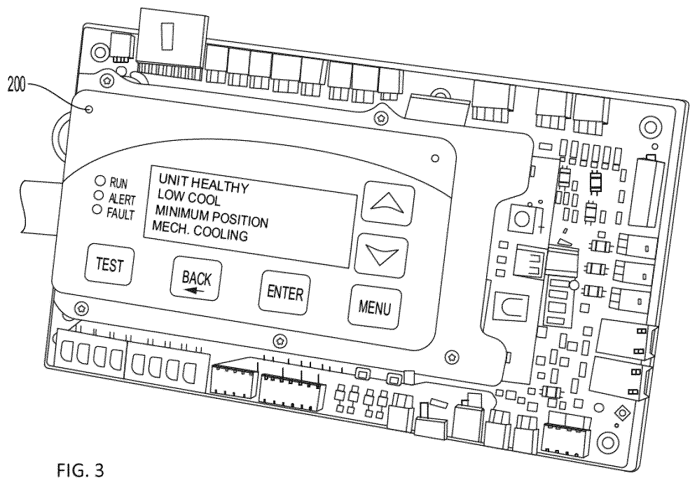

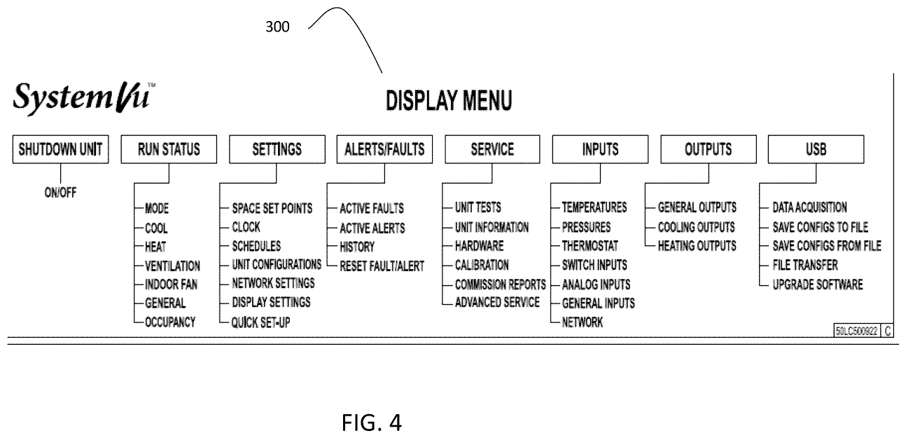

The portable media also contains identification information about the installation files and the dates, validity, target site as well as checksums, time stamps and verification mechanisms to match the configuration for a site specific unit. Once on premises, the portable media is inserted into a reader on the environmental control device (e.g. an HVAC system) and loaded through an auto-load program. This autoload program may vary from one manufacturer to another, but generally it will be a software on the computerized controller (FIG. 3) which uses the USB drive's configuration file. The software for generating the configuration file is provided with information of what equipment is present at a facility when creating the configuration file. Particularly, the autoload program may be stored on the USB device or otherwise included with the configuration file or may be already installed on the controller of the environmental control device. Insertion of the portable media into the HVAC control panel allows for the configuration file to be read and then stored on a storage of the controller such that the controller's processor can read and use the configuration file. In preferred aspects a removable storage such as a singular USB thumb drive is inserted into the HVAC unit for upload. Once uploaded, and a baseline established, more granular configuration changes can in some cases be made remotely via network connections such as BacNet (Building automation and control networks). More generally though, the configuration file is in many cases recognized by the unit controller (FIG. 3) as a backup or restore file that causes the unit to reboot or otherwise reset using that new configuration file to implement the settings referenced in that configuration file. Thus, instead of the user needing to scroll through the multiple tier menu system (FIG. 4) to change settings one by one, the generated configuration file can change multiple settings at once which settings would otherwise require clicking through multiple different menus on a small and rather cumbersome display.

Subsequent steps to validate that the installation worked successfully are also contemplated, with verification of key parameters. Additionally, where supported, date stamps and check sums are also used. Once the USB drive is inserted, depending on manufacturer, a simple set sequence of operations is executed to confirm upload from USB drive. This avoids the need for the installer to scroll through all the various configuration menus to implement each configuration setting one by one as the present solution provides multiple settings otherwise accessible within the configuration menu are implemented together upon implementation of the configuration file (i.e. without the need to scroll through menus). Once the configuration file is installed, the controller may then return a message indicating the upload was successful and the controller will automatically be rebooted. At this time, settings can be spot checked to ensure upload was successful and that the configuration was indeed intended for a target device and properly loaded. Some units also send updates electronically to the central system and in some cases, some if not all parameters can be queried from remote for validation. As more optimal configuration settings are discovered over time, a version control system is provided to track which units are configured under which version so that it is possible to determine that an update is needed for the next visit by a technician. Thus, each configuration file may have a unique identifier associated therewith at the central computer and software which generates the configuration file. This identifier may be reported back to the central computer either periodically or each time the configuration is changed.

Environmental conditioning/control units/devices generally come pre-programmed without the ideal configuration, and there are many options available that should be selected based on different installation parameters. In the example of some RTU devices, when these are obtained from the factory, they are designed to hit room temperature targets around 78 degrees. Because of this, once units have return temperatures in this range the delta T between supply and return gets closer and closer together meaning the unit will run much longer than necessary to get to temperatures typically expected when air conditioning, namely 70-72. Experience in settings these configurations leads to lowering the discharge air temperature setpoints of units allowing the units to still have delta T ranges in cooling of 15-20 degrees even when close to the desired temperature set at the thermostat.

Manufacturers may also have inappropriate factory defaults for a given installation or a given region. In some cases, the factory economizer minimum position setting at blower speeds 0-99% of 0% and at 30% when the blower is at 100% are set up. Being that the fan only spins at 100% when you need cooling or heating the most, there are use cases where on extremely hot or cold days the unit begins to bring in too much outside air and the conditioned space gets further away from the desired temperature even though the BTU's of work being done from the unit have increased. Minimum position settings on economizers are typically set to bring in a consistent amount of CFM from outside so as the blower slows down you want the economizer damper percentage number higher, and as it increases in speed that number should come down. This allows a more consistent CFM of outdoor air coming into the space regardless of blower speed. Once again, a typical installer will note realize these settings and they may not be obvious on the day of the install, only coming out on these overly extreme days when the problem manifests itself.

In some HVAC equipment there are fan off delays that can be used to use every bit of heating or cooling work that has been performed even when the thermostat call has been satisfied. When the call is satisfied the compressors or heat exchanger will turn off and by programming the fan off delay to an ideal setting the unit can have the fan continue to run so as to use the remaining BTU's in either the evaporator coil or heat exchanger in the space improving efficiency. Past taking advantage of that remaining energy, doing this in heating mode also helps prevent the residual heat from the heat exchanger from overheating the blower motor and VFD/ECM controls resulting in longer component lifespans and less maintenance. Once again, these settings are not part of the default setting, will generally be overlooked by technicians, and only those trying to obtain every last unit of efficiency from a unit would venture into the level of detail to discover and obtain these.

While fan delays in some instances help as previously listed, sometimes they can be a waste of energy. In cooling mode there is no reason to have the outdoor fans run for an extended time as the coil will return to ambient temperatures very shortly after the compressors shut down. Certain manufacturers do keep these fans spinning for 30-60 seconds wasting energy for no reason and potentially bringing in warmer air. Lowering this to zero and having a minimum compressor off time accomplishes the same goal of the outdoor coil returning to ambient outdoor temperatures and compressors should have time between off/on cycles anyway for longevity purposes.

Furthermore, Occupancy is an important input for units and different manufacturers of HVAC equipment have different requirements to have this communicated to the equipment from the thermostat or control device. By programming this input to match that of another input systems can properly obtain and leverage to their advantage an isolated occupancy communication without needing to replace the communication or thermostat wires at a given location.

The above are simply a few examples of configurations used to illustrate why so many installers get it wrong, and results may be inconsistent across sites. Typically, the ability to configure a unit to run based on various peripheral sensors and their data is not well understood and therefore not implemented. As units have evolved, the level of complexity has increased and it is difficult to foresee every scenario and configure the site ideally, especially with the growing efficiency based features and the growing number of sensors available. The USB key configuration management system deploying ideal configurations facilitates the installation with a consistent easy to load fashion and ensures that the various units and their associated peripherals such as sensors, data feeds and the like are connected properly and the unit configured correctly.

Additionally, the system monitors performance and measures consumption through metering. This provides a feedback loop to a central system where data can be collected, and configuration settings can be assessed and compared to expected performance.

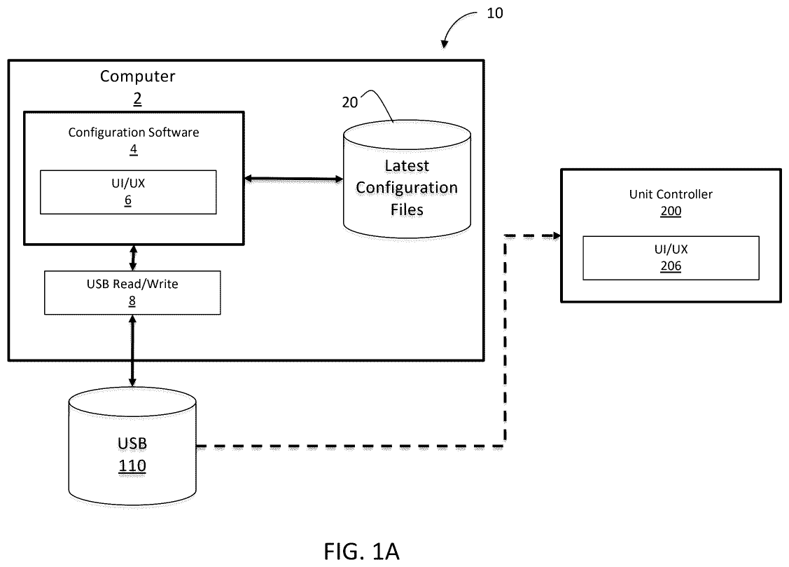

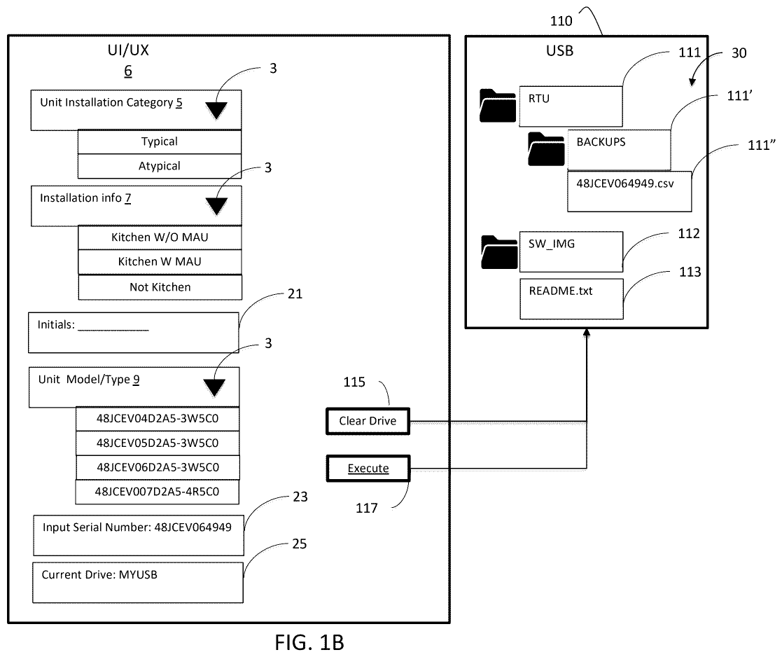

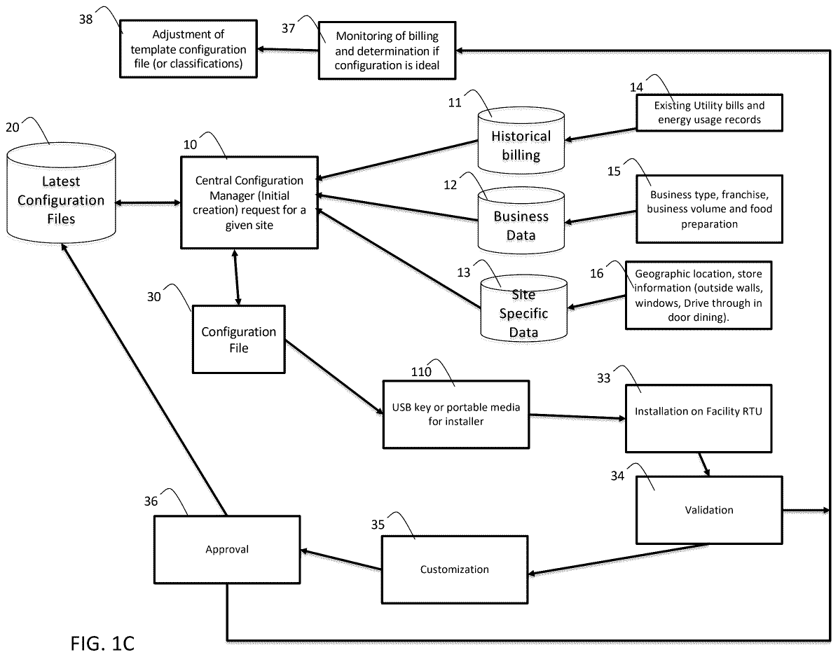

FIG. 1A shows the configuration manager 10 which may be a computer 2 with software 4 executing thereon. The computer could be a mobile device, a server, a PC or one of many other types of computing devices know to those of skill in the art. The configuration software provides a user interface 6 which allows for inputs about the specific installation to be made. The software 4 has access to the latest configuration files 20 used with other installations as a data store used for generating the configuration file for the particular unit that a configuration file is being prepared for. A removable storage such as a USB 110 is connected to the computer 2 and then once the configuration file is generated and stored on the USB, the USB is brought to the unit controller 200 which is on site at a particular location and which also has a user interface 206. The installer at the site will load the configuration file onto the controller of unit in question. This may be done automatically by the controller simply by the installer connecting the USB 110 to the controller 200. In some cases, a shorter menu selection may be needed to load the configuration file to the controller 200. However, once loaded, the configuration file provides multiple settings for the environmental conditioning unit such that the installer is not required to select these settings one by one by going through the controller 200 menus for each individual setting. Rather, the configuration file selects multiple settings at once, ensuring accurate configuration of each unit according to the installation parameters at each site.

FIG. 1B shows more details on the user interface 6 of the configuration software 4. As shown there are several drop down menus 3 that give the user various options. These are only a few examples of options provided and many more are possible such as settings indicative of climate, installation location, other conditioning devices and heat/cooling generating devices on site (e.g. kitchen devices such as refrigerators, coolers, cooktops, fryers, ovens etc). These selections can indicate different permutations or combinations of configuration settings that should be implemented and which are then implemented in the generated configuration file. The unit installation category 5 may allow for selection of typical or atypical installation categories. The installation information 7 may indicate that the environmental conditioning unit is in (or will be in) a kitchen with or without a makeup air unit or not in a kitchen. These are but some installation information examples that impact the configuration to match it to the needs of the particular site. A type box is provided 21 where the person creating the configuration file can add their initials or some other data. This information is included in the configuration file or an information file to indicate who created it. Next, the type of unit selection 9 is provided where the model number can be selected. Each model number may indicate different features and configuration options and sensors 601 available. The sensors may external to the unit or internal to the unit and may further obtain data from other devices in the facility. Referring back to FIG. 1B, an input box 23 is provided to add the serial number and file storage identifier 25 identifies the removable USB 110 that is being formatted and the configuration file provided to. The user interface provides an option to clear the drive 115, this erases all data from the drive and formats it to the appropriate format (e.g. FAT 32 etc). The formatting and erasure of data may be important to the controller 200 since the wrong format or extraneous data may confuse the controller 200 to the point that it becomes inoperable (colloquially referred to as “bricked”). The next option to execute 117 the configuration file creation will add the file structure and format to the usb 110 that is needed for the controller 200 in question. The user selecting the execute 117 button may also cause the drive to first be cleared and formatted 115. Once executed 117, the USB 110 will have a folder structure and format that the controller 200 expects to see. This may be specific folders 111, 112 and sub folders 111′ and a particular location of the data file 111″. As shown, a readme.txt file 113 is provided and this may include the time stamps and who create the file. The titles of the folders shown may be necessary for the particular installation and may differ depending on which unit type 9 is selected in the user interface. The now prepared configuration file on the USB 110 can be brought to the site and provided to the controller. The SW-IMG 112 folder may include firmware or firmware updates for the controller 200. FIG. 1B shows a simplified option list which may drive the configuration decisions, but many other options can be made available including but not limited to: Combination units (2 paired units which will be controlled by 1 source), BACnet or BMS units, so that networking and BACnet settings could be pre-loaded (BAC referring to Building Automation Control networks and BMS referring to building management system networks), Kitchen with/without makeup air, Location/geographic zone, Demand Response via Unit (for example, instead of via thermostat) , Tonnage/SqFoot and other site/installation parameters. Some or all of these options may be provided under the “Atypical” menu tree, but may also be provided in the “Typical” menu tree.

FIG. 1C shows the central configuration manager 10 which accesses all the latest and most up to date configuration files 20 which are managed for the sites. These configuration files are classified based on the site-specific information and the most appropriate configuration file 30 for a given site is provided to the installer as they prepare to go to the site on portable media 110 device. The configuration file 30 is provided by the central configuration manager 10 based on a variety of factors derived from historical billing 11 for the site which uses existing utility bills and records for a site, which may include metered data. Additionally, business data 12 based on factors 15 like the business type, size, volume is used as well as site specific data 13 which is taken from data 16 such as the geographic location and store information such as the construction data including exposed walls and other factors that may affect energy consumption. This all is in addition to the identification of the environmental control units and their peripherals that are to be part of the installed system (such data may also be considered part of the site specific data 13 if applicable). In some cases, the configuration software provides a user interface or a data upload that allows for the selection of these units and peripherals as shown in FIG. 1B. The locations are classified based on the expected energy usage and the system proposed RTU settings in the configuration file 30 for a new site based on classification data that puts it in the same classification and prior sites that are similar.

The installer takes the portable media configuration file 110 and installs it at the facility 33 and a validation 34 process is done. This may involve local checking that configuration is properly installed and that the RTU is working properly and may also include remote monitoring and diagnostics or querying. Once installed, the system will monitor on going site performance 37 viewing billing and energy usage records over time and if necessary, make adjustments 38 to the file 20 causing a new version of the configuration file to become the new standard 20 for this classification of facility. As part of the adjustment 38 process, the system may also decide to separate the classification, or potentially combine classifications thus adjusting the number of files being used. As an example, if initially sites had been classified based on menu, but it is determined that menu has no noticeable impact on energy use, the system may combine the classifications and have a single configuration file for combinations of other parameters 13, 12, 11 without the menu. Similarly, if the classification of site data 13 first classified sites into 0-1000 sq ft, but the system sees that there is a noticeable difference in sites that are 0-500 and 501-1000 sq ft, the system can split the classification and assign two unique configuration files for each new classification based on size.

In some cases, a new classification of facility may be installed, and the existing classifications do not provide a proper fit, the best or closed configuration file 30 is proposed and placed on the USB key 110 and installed on the site 33. In the validation 34 phase it is possible that some customization 35 is done, and if this customization 35 is to be standardized, it is approved 36 to be included for future similar sites as a baseline configuration. Over time, as more sites are installed the classification system has more configuration types.

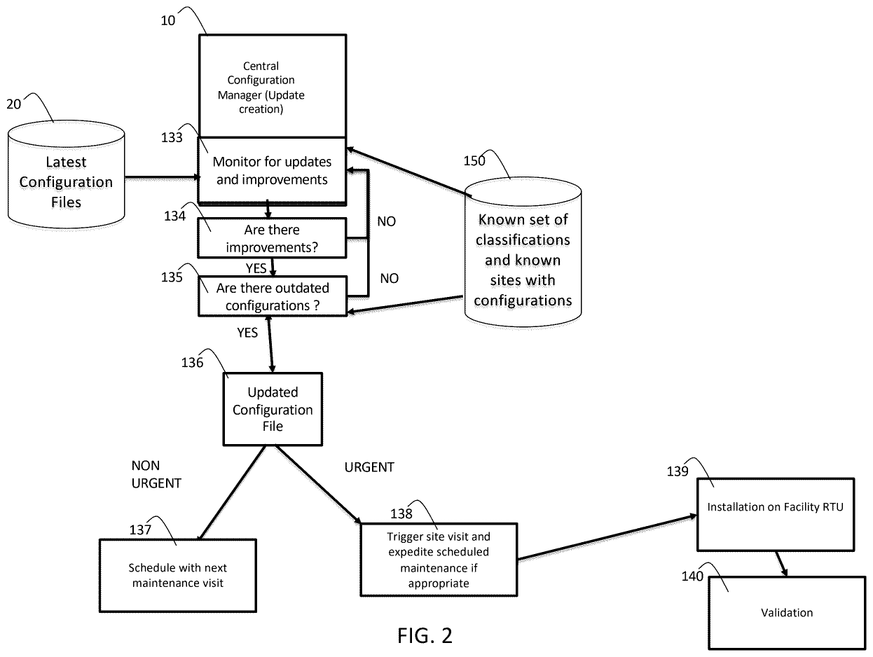

FIG. 2 shows the central configuration manager 10 that is monitoring 133 the latest configuration files 20 for any changes for the known set of sites 150. If improvements 134 are found 135 the system looks to see which if any sites have outdated configuration files installed. If so, a new configuration file is selected for the site and if non-urgent it is earmarked for the next scheduled maintenance 137 at the site. If urgent, a site visit is triggered 138 and the new configuration file is installed 139 at the facility and again validated 140. Urgency may be determined based on potential for energy savings or even potential for equipment failure, or degradation, or otherwise detrimental elements of the existing configuration and benefits of the new configuration being used. The timeliness of the next scheduled maintenance also comes into play in that if a maintenance window was approaching anyway, we may opt to escalate the maintenance to benefit from the new configuration.

FIG. 3 shows a sample local screen on an HVAC controller 200 simply to illustrate the complexity of using such a device to provide the configuration at a given site.

FIG. 4 also shows a sample menu configuration 300 of an HVAC unit controller 200 again to illustrate the complexity of such menu system

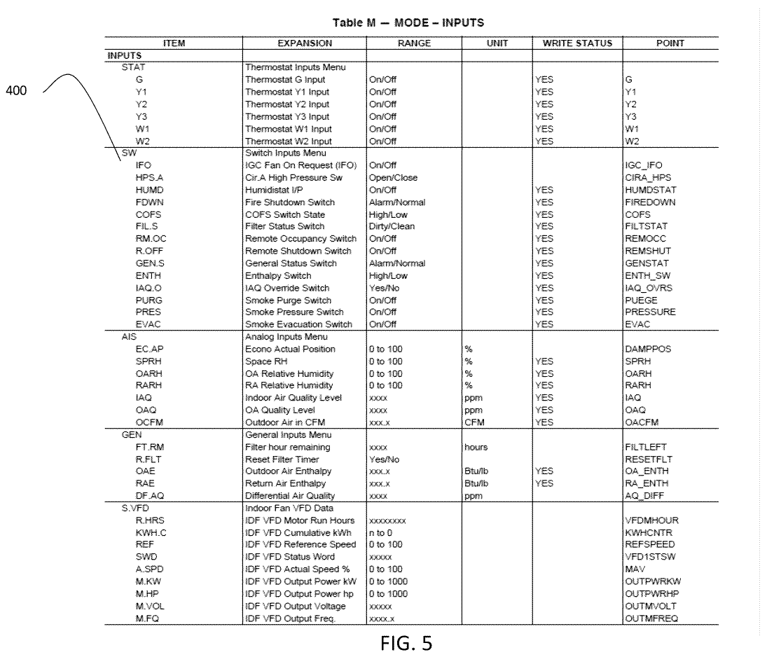

FIG. 5 shows a sample subset of parameters 400 again to illustrate how these are generally above and beyond the average comprehension of installation technicians doing HVAC installations. It should be noted that 200 or more parameters may exist on a typical RTU and this figure shows only a few of the parameters.

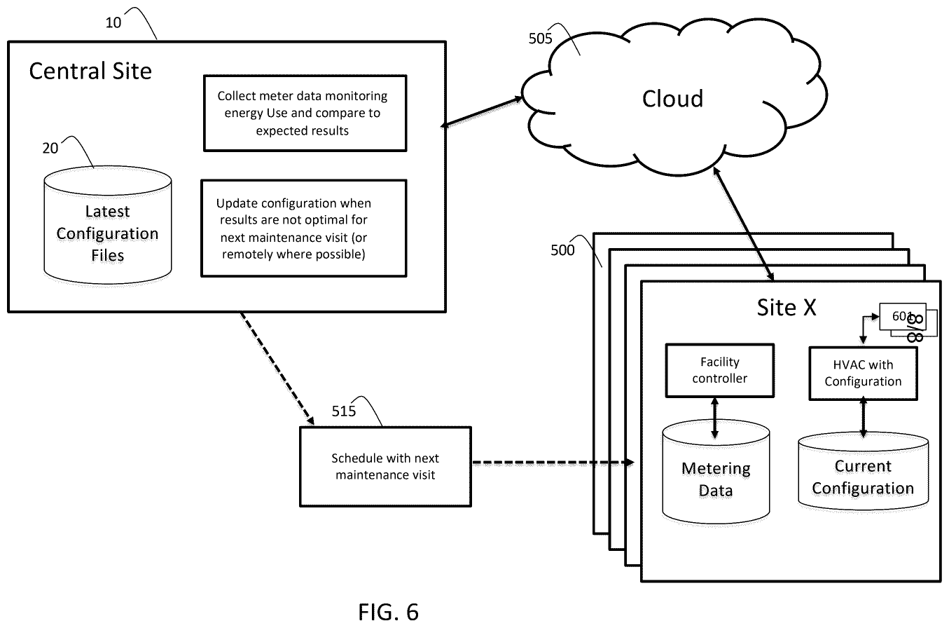

FIG. 6 shows a sample configuration of multiple sites showing how the system monitors and manages configurations. A central site 510 encompassing the latest configuration files 20 collects metering data through the cloud 505 from one or many sites 500 provided by a facilities controller that is metering energy use. The site 500 has a given known configuration for the HVAC which was provided by the central site 510 the version, which is known as shown, various sensors 601 of the HVAC may need to be configured properly. If the collected meter data does not reflect the expected energy usage the central site 510 updates the configuration file for the given site 500 and dispatches the new configuration with a technician for the next installation or maintenance visit 515. Where supported, the central site 510 can also send the new configuration 20 through the cloud 505 to the given site 500.

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting. It is further understood that all communication between the various entities may be done electronically and handled by the various computers/software associated with each entity and their location(s).

What is claimed is:

1. A method of configuring environmental conditioning units comprising:
providing a selection indicative of one or more environmental conditioning units having one or more sensors, at least one of the environmental conditioning unit having a controller providing an interface for selection of a plurality of configuration options at least some of which relate to the one or more sensors;
generating, with a software executing on a computer, a configuration file based on said selection, said configuration file having two or more of said plurality of configuration options included therein as chosen configuration settings;
providing said configuration file via the storage to the controller to implement the configuration file within the controller such that the at least one of the one or more environmental conditioning units operates with the one or more sensors based on the configuration file and the configuration file includes a plurality of configuration settings which would otherwise be selectively chosen via the interface but which configuration options, by implementation of the configuration file are configured in the controller without navigation through the interface for each of the plurality of configuration settings.

2. The method of claim 1 wherein prior to providing said configuration file to the controller, said configuration file is saved to a storage which is removable from communication with said computer and providing said configuration file includes connecting said storage to the controller.

3. The method of claim 1 wherein said configuration file is provided to the controller wirelessly from said computer.

4. The method of claim 3 wherein said computer is a mobile device.

5. The method of claim 2 wherein the configuration file on said storage is stored with a file structure and a format which is acceptable by said controller.

6. The method of claim 5 wherein said structure and format is recognizable by said controller as a backup or reboot file such that the controller accepts the configuration file as if the controller were restoring or rebooting from said configuration file.

7. The device of claim 1 wherein the configuration file includes a plurality of files.

8. A device for configuring environmental conditioning units comprising:
software executing on a computer which software is configured to receive installation details comprising: information indicative of an environmental conditioning unit type and unique identifier and at least one installation information associated with installation of the environmental conditioning unit at a site;
said software configured to identify a removable storage and to format said removable storage based on the installation details and said software further configured to generate a configuration file for the environmental conditioning unit and store said configuration file on the storage, wherein the configuration file is configured such that the at least one of the one or more environmental conditioning units operates based on the configuration file and the configuration file includes a plurality of configuration settings which would otherwise be selectively chosen via an interface of a controller of the environmental conditioning unit but which configuration options, by implementation of the configuration file are configured in the controller without navigation through the interface for each of the plurality of configuration settings.

9. The device of claim 8 wherein the configuration file on said removable storage is stored with a file structure and a format which is acceptable by said controller.

10. The device of claim 9 wherein said structure and format is recognizable by said controller as a backup or reboot file such that the controller accepts the configuration file as if the controller were restoring or rebooting from said configuration file.

11. The device of claim 8 wherein said format is matched to a format acceptable to the controller based on the environmental conditioning unit type.

12. The device of claim 8 wherein said configuration file includes the unique identifier.

13. The device of claim 12 wherein the unique identifier is contained in a file name of the configuration file.

14. The device of claim 8 wherein a storage accessible to said software and containing data indicative of configuration settings to be used based on which installation details are selected at the software such that the configuration file is generated by said software based on the data.

15. A method of configuring an environmental conditioning device comprising:
providing a storage containing a configuration file particular to an environmental conditioning unit type and unique identifier and at least one installation information associated with installation of an environmental conditioning unit at a site;
connecting said storage to a controller of the environmental conditioning unit at the site to configure a plurality of settings of the environmental conditioning unit based on the configuration file such that the controller obtains the plurality of settings from the configuration file which settings would otherwise be selectably chosen via an interface of a controller of the environmental conditioning unit but which configuration options, by implementation of the configuration file are configured in the controller without navigation through the interface for each of the plurality of configuration settings.

16. The method of claim 15 wherein the controller includes a controller storage, and the configuration file is transferred from the storage to the controller storage and stored on the controller storage.

17. The method of claim 15 wherein the configuration file on said storage is stored with a file structure and a format which is acceptable by said controller.

18. The method of claim 17 wherein said structure and format is recognizable by said controller as a backup or reboot file such that the controller accepts the configuration file as if the controller were restoring or rebooting from said configuration file.

19. The method of claim 14 wherein the configuration file includes a plurality of files.

20. The method of claim 14 wherein the configuration file includes the unique identifier in the file name and the controller recognizes the configuration file based on the file name.
